(19) United States
(12) Patent Application Publication
(10) Pub. No.: US 2002/0078926 A1
(43) Pub. Date: Jun. 27, 2002

(54) Magnetically energized ignition system for a small engine

(76) Inventors: Sascha Kolossow, Hamburg (DE); Klemens Krahn, Norderstedt (DE)

Correspondence Address: McCormick, Paulding & Huber LLP, CityPlace II, 185 Asylum Street, Hartford, CT, 06103-3402, US

(21) Appl. No.: 09/917,000

(22) Filed: Jul. 27, 2001

(30) Foreign Application Priority Data
Aug. 8, 2000 (DE) 200 13 968.1

(51) Int. Cl. F02P 1/00; F02P 3/06

(52) U.S. Cl. 123/406.57; 123/599; 123/613; 123/635; 123/634

(57) ABSTRACT

A magnetically energized ignition system (10, 24) for a small engine includes a rotary magnet system (11, 25) driven by the crank shaft of the engine, a charging coil (12, 26) in which a voltage is induced by the rotating magnet system (11, 25) an energy store (12, 28) which is charged by the charging coil (12, 26), a voltage converter (19, 34) which is connected with the energy store (12, 28) and creates a transformed high ignition voltage, a spark plug (23, 35) connected with the output of the voltage converter (19, 34), a crank shaft position indicator (14, 29), and a switch element (13, 27) controlled by the crank shaft position indicator and which has an effect on the energy store (12, 28), and reduces the disadvantages of known ignition systems, especially saving costs in respect to known ignition systems, especially by making possible the saving of costs in respect to high voltage cabling, the ignition system also being particularly suited to the narrow space requirements of small motors in that the voltage converter (19, 34) is arranged directly at the spark plug (23, 35) and being located in a spark plug connector (18, 34) which is fastenable to the spark plug by a known slip-on arrangement without additional fastening elements.

### FIELD OF THE INVENTION

The present invention is concerned with the field of small combustion motors, such as are used for example in motor driven hand working devices, such as chain saws or the like. In more detail, the invention concerns a magnetically energized ignition system for a small engine of the type wherein the ignition system includes a rotating magnet system driven by the engine, a charging coil excited by the rotating magnet system, an energy store charged by the charging coil, a voltage converter, a crank shaft position indicating means, and a switch element which is controlled by the crank shaft position indicating means and which has an effect on the energy store.

### BACKGROUND OF THE INVENTION

Magnetically energized ignition systems are known in which the charging coil, the energy store, the voltage converter (or high voltage generator), as well as, if applicable, the crank shaft position sensor, the switch element, and if applicable, a driving condition dependent delay element, are integrated into one housing, which housing is arranged directly at the rotating magnet system for making available the needed energy. Several electrical terminals are arranged at the housing with at least one being a high voltage terminal for a conventional ignition cable. The energy store can consist of a capacitor or of a coil.

Also known are systems according to the above-mentioned construction, in which the energy store and the voltage converter are integrated into one component, the ignition coil, which is contained in a separate housing and is made available to a conventional ignition cable by a high voltage terminal.

Further known are battery energized ignition systems for (larger) multiple cylinder engines, whose ignition coils are integrally connected with the spark plug connecting means. These systems in comparison to conventional battery energized systems with mechanical high voltage distribution are to the point in that:

the troublesome, maintenance intensive mechanical high voltage distributor is done away with;

the weight of the individual ignition coils is lower than the weight of a central ignition coil;

the high voltage cabling likely to cause electrical disturbances is done away with;

by the measurement of voltage and current at the secondary side of the ignition coil, by the motor control computer, conclusions about the quality of the ignition, the combustion in the associated cylinders or an eventual possible pre-ignition can be arrived at, in order to optimize the running of the engine and to diminish the emission of harmful exhaust.

As disadvantages the arrangement of the enlarged size connectors over the spark plugs in the narrow space conditions of a multiple cylinder engine, and the high thermal input of the engine heat into the ignition coils, have to be taken into account.

In the case of small engines other problems appear with known ignition systems or ignition devices:

known magnetically energized ignition systems for small motors can be applied spacewise only with difficulty, especially in the case of hand manipulated work tools.

the placement of the housing of known ignition systems imposes a severe disadvantage for cooling air delivery at the combined magnetic pole and air wheels in blower cooled engines. Therefore, an increased energy consumption for the creation of a given airflow arises. In the case of a smaller housing located in the air stream a savings effect can be achieved.

because of the shape of known ignition systems, gaps which are located in the air stream between the ignition housing and the machine housing can accumulate dirt and dust, which leads to a lowering of the cooling air stream and to an increased energy consumption in the creation of the air stream. Moreover, the dissipation of heat from the outer surface of the ignition housing is impaired. Moisture can embed itself in the dirt so as to lead to the corrosion of the metallic parts of the ignition system, and can also lead to a shunt or short circuit between electrical parts of the ignition system.

known magnetically energized ignition systems have a high voltage cable as the connection between the high voltage generating component and the spark plug. This cable is especially sensitive to heat, aging, and mechanical damage. Aging is among other things accelerated by the heat radiated from the motor. By the damaging of the insulation short and shunt circuits can arise, which are encouraged by the high voltages in the cable as well as by the dirt and moisture contained in the engine cooling air. Moreover, the electric conductor of the cable can become interrupted.

the high voltage cables used in known ignition systems form, among other things, a capacitive load for the ignition system, especially in the case of the placement of the cable in a metal housing connected with the ground terminal of the spark plug. In this way, the energy requirement of the spark gap is negatively influenced.

It is already known, in the case of a magnetically energized ignition system to arrange the voltage converter directly on the spark plug (U.S. Pat. No. 5,590,637). This known construction variant requires however a large construction space and an insulated support of the housing.

It is also known to arrange the voltage converter next to the spark plug (U.S. Pat. No. 3,935,852).

An ignition coil insertable onto the spark plug is known from JP59-12165A.

In none of these known solutions is a customary spark plug connector provided.

### SUMMARY OF THE INVENTION

It is therefore, the object of the invention to provide a magnetically energized ignition system for small engines which avoids the disadvantages of known ignition systems and which especially makes possible the sparing of a high voltage cabling, and which is suited to the narrowly limited space conditions found in small engines.

This object is solved in that the voltage converter is arranged directly at the spark plug, and that for the connection to the spark plug a spark plug connector is provided wherein the voltage converter is integrated with the spark plug connector, the spark plug connector being placeable onto the spark plug by way of known slip-on connecting means and without additional fastening elements. The core of the invention exists in that the high voltage necessary for the ignition is created by a voltage converter directly at the spark plug. This way the high voltage cabling between the location of the magnet system and the location of the spark plug can be eliminated. At the same time, the cooling air stream is less influenced by the placement of the voltage converter. An especially essential feature exists in the simple and space saving shape refinement, by which it is provided that for the connection to the spark plug a customary spark plug connector is used, and in that the voltage converter is integrated with the spark plug connector. An especial advantage exists in that the known spark plug connector is fastened with a slip-on connecting means to the spark plug, whereby in a DIN terminal a spring receives a threaded section, while in the case of an SAE terminal a customary clip receives a fastening lug and snap fittingly holds the spark plug. In contrast to this, the known proposals in which a voltage converter is arranged in the area of the spark plug all have additional fastening elements in the form of clamping brackets, supplemental screws or the like, which are done away with in the new embodiment.

For the making of a spark plug connector in accordance with the invention, which is both especially space savingly shaped and advantageous for hand working tools, it is proposed that a section of the housing which partially receives the spark plug, and another section of the housing which contains the voltage converter, are arranged at an angle relative to one another with the angle being preferably about 90°.

Preferably the charging coil and the switch element are arranged remotely from the spark plug directly at the magnet system, and the charging coil and the switch element are connected with the voltage converter through a cable connection.

It is further imaginable that the energy store is also arranged at the spark plug.

According to a preferred development of the invention the ignition system is formed as a coil ignition and the charging coil serves also as the energy store, with the crank shaft position indicator being a switch cam and with the switch element being a switch contact.

According to another preferred development of the invention the ignition system is formed as a capacitor ignition and the energy store as a capacitor, with the crank position indicator being a control coil inductively excited by the magnet system and the switch element being a semiconductor switch, preferably a thyristor.

### BRIEF DESCRIPTION OF THE DRAWINGS

The invention will hereinafter be explained in detail by way of exemplary embodiments in combination with the drawings. The drawings are:

FIG. 1 The circuit diagram of a first preferred embodiment of an ignition system in accordance with the invention in the form of a coil ignition; and

FIG. 2 the circuit diagram of a second preferred embodiment of an ignition system in accordance with the invention in a form of a capacitor ignition.

### DETAILED DESCRIPTION OF THE PREFERRED EMBODIMENTS

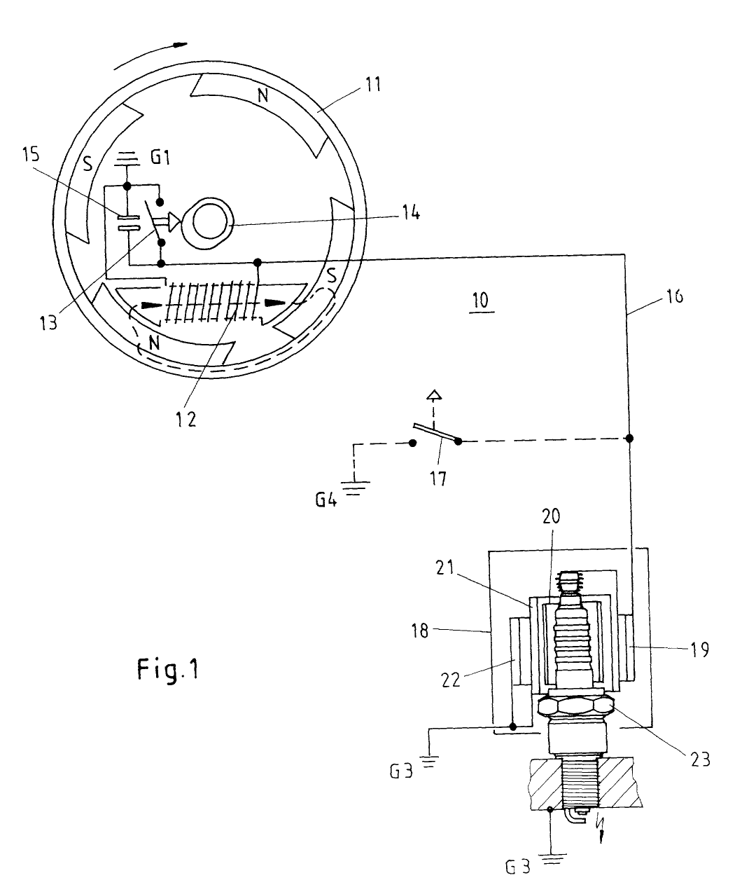

FIG. 1 shows the circuitry of a first preferred embodiment of an ignition system in accordance with the invention in a form of a coil ignition. The ignition system 10 comprises a rotating magnet system 11 driven by the engine, a switch cam 14 as the crank shaft position indicator, a switch contact 13 as a switch element, a charging coil 12 as a charging unit and as an energy store connected with a first ground point GI, as well as an ignition transformer 19 as a voltage converter. In the ignition transformer 19 are a coil core 20, and the primary coil 22 and the secondary coil 21 arranged together, which coils are on one side connected with a second ground point G3. The ignition transformer is a component of a spark plug connector 18, which is stuck onto a spark plug 23 connected on one side to a ground point G2.

The functioning principle of the ignition system 10 of FIG. 1 can be described as follows:

Because of the rotation of the magnet system driven by the engine, when the switch contact 30 is closed a voltage is induced in the winding of the charging coil 12. Because of this voltage there results a current flow through the closed switch contact 13. This current flow is broken at a suitable moment, preferably when the current is highest, when the switch cam 14 opens the switch contact 13. This suddenly changes the direction of the magnetic flux in the core of the charging coil 12 and induces a voltage impulse which reaches the ignition transformer 19 over the cable connection 16 (designed for more than 100V) and is there transformed to a higher value. The high voltage (typically 9-15 kV) from the secondary winding 21 leads to a spark gap breakdown at the gap of the spark plug 23. In the described example, the provided capacitor 15 reduces the burning off of the contact surfaces of the switch contact 13 and strengthens the voltage impulse created by the opening of the contact.

Optionally, the cable connection system 16 can be connected through a key 17 to the ground point G4. In the event of an actuation of the key 17 no spark gap breakdown will occur at the spark plug 23 and the motor will be stopped by the lack of combustion.

The ignition transformer is, in the given example, so integrated into the spark plug connector 18 that upon the sticking of the connector onto the spark plug 23 the insulator of the spark plug 23 is moved into the hollow coil core 20 which isolates it against the high voltage. The primary and secondary coils 22 and 21 are arranged concentrically on the coil core.

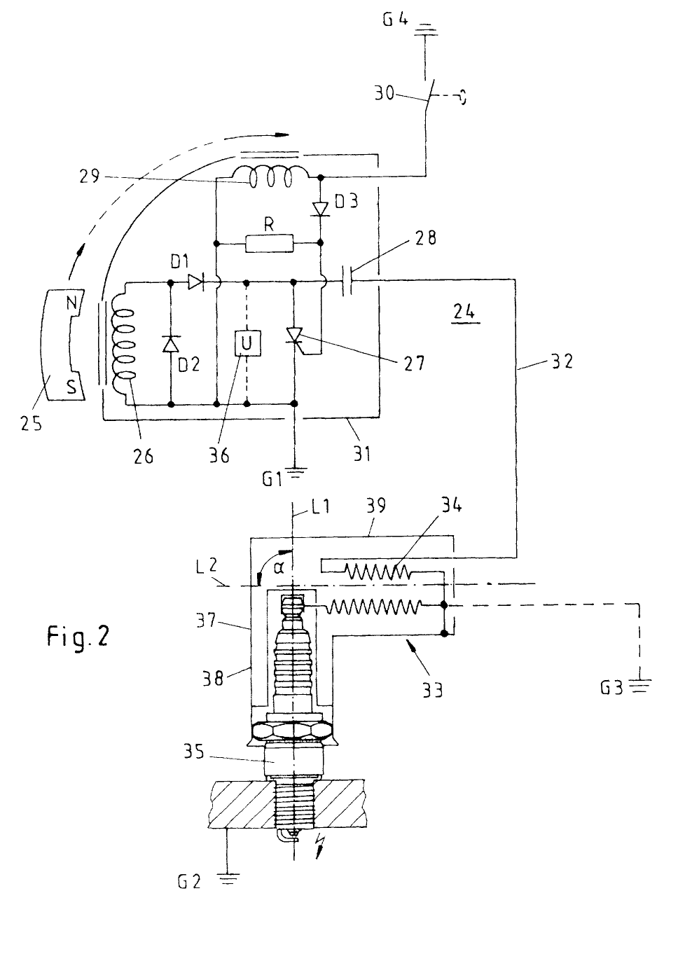

FIG. 2 shows the circuit of a second preferred embodiment of the ignition system in accordance with the invention in the form of a capacitor ignition (CDI=Capacitor Discharge Ignition). The CDI system comprises a charging unit, a capacitor 28 as the energy store, a control unit, a switch element, and a transformer 34 as the voltage converter. The charging unit connected on one side to the ground point G1 is made up of a charging coil 26, in which a voltage is induced by the magnet system 25 driven by the engine, as well as a first diode D1 as a rectifier, and the capacitor 28, which together form the energy supply for the system. The control unit comprises a control coil 29, which because of the rotating magnet system 25 at a given crank shaft position has induced in it an electrical impulse, a second diode D3 as a rectifier, and a resistance which influences the timewise appearance of the pulses induced in the control coil. A thyristor 27 is used as a switch element in the given example.

In the given example, the charging unit 26, D1, the energy store 28, the control unit 29, D3, and the switch element 28 are contained in the housing 31 which principally is arranged directly in the vicinity of the rotating magnet system 25. The transformer 34 is, on the other hand, contained in a spark plug housing 37 together with the slip-on connector for connection with the spark plug 35. The transformer 34 in the spark plug housing 37 is connected with the other components of the ignition system 28 over a cable connection 32 and a ground connection (ground point G3). The spark plug connector 33 has a space saving compact construction, in that a housing section 38 of the housing 37 of the spark plug connector 33 which partially receives the spark plug and another housing section 39 of the housing 37 of the spark plug connector 33 containing the voltage converter 34 have an angle α of about 90° relative to one another.

The functional principle of the CDI-System during rotation of the engine can be described as follows:

If the magnet of the magnet system 25 (for example a magnetic pole wheel) moves by the charging coil 26, an electrical voltage is induced in its winding by the change of the magnetic field in the coil core. As a result of this voltage an electrical current flows through the primary winding of the transformer 34 as well as through the first diode D1 and charges the capacitor 28. At this point of time the current flow through the thyristor 27 is a blocked. During the further rotation of the magnet system 25 the magnet passes the control coil 29, in the winding of which an electric voltage impulse is created. This impulse is rectified by the second diode D3 and controls the thyristor 27. Thereby the capacitor 28 is discharged by a current flow through the thyristor 27, the ground connection G1, the primary winding of the transformer 34, and the connecting conductor 32 between the two housings 31 and 37. In the course of the discharge a high voltage impulse is induced in the secondary winding of the transformer 34, which has the result of causing a spark gap breakdown at the gap of the spark plug 35.

In the given example the third diode D2 serves to short circuit negative voltage impulses of the charging coil 26 whose spikes could damage the first diode D1, as well as to quickly lead away the remaining charge of the capacitor 28 created by the inductance of the primary winding of the transformer. The resistance R influences, by its effect on the time wise course of the voltage pulses induced in the control coil 28, the point of time at which the spark occurs at the spark plug and has thereby direct influence on the ignition timing in independence on the engine speed. In other given system the resistance R can optionally be replaced or supplemented by an analog or digital electrical switch, which increases the range over which the timing of the spark can be changed (in connection with this see for example, Patents DE-A1-3608740 and DE-A1-3817471).

The optionally illustrated component U of the given example is a voltage regulator which protects the thyristor 27 from extremely high voltage spikes. The optional key 30 working as a short circuit switch connects the control coil 29, in the keyed condition of the switch, to the ground point G2 so that a discharge of the capacitor 28 and thereby a spark at the spark plug is prevented. The combustion engine is thereby stopped because of the absence of a spark for igniting the mixture. Further possibilities for the forming of a short circuit switch exists, as for example, at the conductor connection between the charging coil 26 and the capacitor 28, as well as between the capacitor 28 and the primary winding of the transformer 34. The short circuit switch then connects, in the event of an actuation of the switch, the mentioned point to ground. The switch is generally only necessary if no other possibility is given for stopping the combustion engine (for example, by the cutting off the fuel supply).

In the given example, the transformer 34 is arranged at a right angle to the middle axis of the connecting area of the spark plug 35 in the spark plug connector housing 37. In the example the spark plug connector housing 37 is made of a current conducting material and has through the plug connection at the base of the spark plug a direct connection with the ground (ground G2). The ground connection of the transformer 34 is made through the spark plug connector housing 37. To isolate the other connections of the transformer the conductive housing 37 is filled with a non-conducting material. Alternatively the housing 27 can be made from an insulating material; in which case the ground connection of the transformer 34 can be made to (ground G3) through a separate connection. The connection between the ground terminal of the transformer 34 and the spark plug connector housing 37 is omitted in this embodiment.

Reference Number List

Reference Number List

| | |
|---|---|
| 10, 24 | Ignition system |
| 11, 25 | Magnet system |
| 12, 26 | Charging coil |
| 13 | Switch contact |
| 14 | Switch cam |
| 15, 28 | Capacitor |
| 16, 32 | Cable connection |
| 17, 30 | Key |
| 18, 33 | Spark plug connector |
| 19 | Ignition transformer |
| 20 | Coil core |
| 21 | Secondary coil |
| 22 | Primary coil |
| 23, 35 | Spark plug |
| 27 | Thyristor |
| 29 | Control coil |
| 31 | Housing |
| 34 | Transformer |
| 36 | Voltage regulator |
| 37 | Housing (spark plug connector) |
| D1, . . . , D3 | Diode |
| G1, . . . , G4 | Ground point |
| R | Resistance |

In the claims:

1. A magnetically energized ignition system (10, 24) for a small engine, said system comprising a rotating magnet system (11, 25) driven by a crank shaft of the engine, a charging coil (12, 16) in which the rotating magnet system (11, 25) induces a voltage, an energy store (12, 28) which is charged by the charging coil (12, 26), a voltage converter (19, 34) which is connected with the energy store (12, 28) and creates a transformed high ignition voltage, a spark plug (23, 35) which is connected with the output of the voltage converter (19, 34), a crank shaft position indicating means of (14, 29), and a switch element (13, 27) which is controlled by the crank shaft position indicating means (14, 29) and which effects the energy store (12, 28), wherein the voltage converter (19, 34) is arranged directly at the spark plug (23, 35), a spark plug connector (18, 33) is provided for connection to the spark plug (23, 35), the voltage converter (19, 34) is integrated in the spark plug connector (18, 33), and the spark plug connector (18, 33) is connectable to the spark plug by way of a slip-on connecting means without supplementary fastening elements.

2. An ignition system according to claim 1, wherein the spark plug connector (33) includes a housing (37) having a housing portion (38) which partially receives the spark plug (35), and the housing (37) has another housing portion (39) which contains the voltage converter 34, which first and second housing portions (38) and (39) have an angle α of about 90° relative to one another.

3. An ignition system according to claim 1, wherein the charging coil (12, 26) and the switch element (13, 27) are arranged at a distance from the spark plug (23, 35) and directly adjacent to the magnet system (11, 25), and the charging coil (12, 26) and the switch element (13, 27) are connected to the voltage converter (19, 34) by a cable connection (16, 32).

4. An ignition system according to claim 1, wherein the energy store (28) is arranged at the spark plug (23, 35).

5. An ignition system according to claim 1, wherein the energy store is arranged separately from the charging coil and the voltage converter, and the energy store is connected with the charging coil and with the voltage converter by electrical conductors.

6. An ignition system according to claim 1, wherein the ignition system (10) is formed as a coil ignition and the charging coil (12) serves also as the energy store.

7. An ignition system according to claim 1, wherein the ignition system (24) is formed as a condenser ignition and the energy store is a capacitor (28).

8. An ignition system according to claim 1, wherein the crank shaft position indicating means is a switch cam (14), and the switch element is a switch contact (13).

9. An ignition system according to claim 1, wherein the crank shaft position indicating means is a control coil (29) inductively excited by the magnet system (25), and the switch element is a semiconductor switch, preferably a thyristor (27).

10. An ignition system according to claim 1, wherein the control coil is part of the charging coil.

11. An ignition system according to claim 1, wherein the crank shaft position indicating means is a Hall effect semiconductor means, and the switch element is a semiconductor switch, preferably a thyristor.

12. An ignition system according to claim 1, wherein the crank shaft position indicating means is a light reflecting mark and the switch element is a semiconductor switch, preferably a photo diode, responsive to light reflected from the light reflective mark.

13. An ignition system according to claim 2, wherein the spark plug connector housing portions are made of a current conducting material electrically connected with other parts of the ignition system by a ground connection.

14. An ignition system according to claim 13, wherein the voltage converter is electrically connected with one of the current conducting housing portions.

15. An ignition system according to claim 13, wherein the energy store is electrically connected with one of the current conducting housing portions.

16. An ignition system according to claim 2, wherein the spark plug connector housing portion containing the voltage converter, consists of a mass of material initially cast in a nearly fluid state, which mass of material after the casting process converted to a rigid or elastomeric consistency, so that the voltage converter is partially or entirely embedded in the cast material.

17. An ignition system according to claim 2, further characterized in that the spark plug connector housing portions having ribs for increasing their outer surface area.
